(19) United States
(12) Patent Application Publication
(10) Pub. No.: US 2015/0188910 A1
(43) Pub. Date: Jul. 2, 2015

(54) POLICY GROUP BASED FILE PROTECTION SYSTEM, FILE PROTECTION METHOD THEREOF, AND COMPUTER READABLE MEDIUM

(71) Applicant: ISWIND DIGITAL ENGINEERING INC., TAIPEI CITY (TW)

(72) Inventor: RAPHAEL TSAI, TAIPEI CITY (TW)

(73) Assignee: ISWIND DIGITAL ENGINEERING INC., TAIPEI CITY (TW)

(21) Appl. No.: 14/141,363

(22) Filed: Dec. 26, 2013

(51) Int. Cl. H04L 29/06; G06F 21/62

(52) U.S. Cl. CPC H04L 63/0823; G06F 21/6209; H04L 63/205

(57) ABSTRACT

A policy group based file protection method is provided and includes the following steps. A file management driver is executed on the client device of the client. The identity data associated with a client is transmitted to the server when connection between the client and the server is established. The server determines whether the client belongs to a policy group according to the identity data. When the server determines that the client belongs to a policy group, the server transmits a certificate of the policy group to the client device. When the file management driver detects a request for executing a file open procedure, the file management driver determines whether to allow a file access application executing the file open procedure and opening the file based on the certificate received, wherein the request is executed by the file access application installed in the client device.

### BACKGROUND

1. Technical Field

The present invention relates to a file protection system, a file protection method thereof, and a computer readable medium. In particular, to a policy group based file protection system, a file protection method thereof, and a computer readable medium.

2. Description of Related Art

Nowadays, almost all the information can be stored digitally and everyone can search and acquire various digitized information easily. However, the digital information that shall be kept as secret is also vulnerable to distributed at the same time. Henceforth, how to effectively manage the authorization information and protect leakage of the digital information such that the digital information asset can be effectively and adaptively protected from unauthorized access has now become a major issue in the information management field.

Currently, a typical information management system generally includes a file server, which stores all the files required to be managed via file encryption and protects the files from unauthorized access. Each individual user who logged on from internet could access the file stored in the file server according to the level of authority assigned and wherein the term access herein refers to editing operations such as copying, pasting, saving, and the like However, it shall be noted that the file protection method described herein cannot effectively prevent the files from unauthorized access. For example, when a file has not been uploaded to the file server, not only that the file is not been protected, the identity of the user accessing the file in the file server also cannot be tracked. As a result, it is still very easy for the file to leak unauthorizedly under the current file protection setting. Additionally, the method of protecting the files stored in the file server may bring operational inconvenience. Particularly, when no internet connection is available, the user is unable to access the file from the file server, thereby reduce the work efficiency.

### SUMMARY

Accordingly, exemplary embodiments of the present invention provides policy group based file protection system, the file protection method thereof, and computer readable medium, which classifies any file stored in the file protection system according to a dynamically-configured policy group by corresponding encrypting the file with a file encryption data. The present invention actively verifies whether the user belongs to the policy group associated with the file so at to determine whether to allow the user to access the file associated with the policy group. Accordingly, the present invention can effectively manage and regulate the file accessing operation, thereby improve the security of the file.

According to one exemplary embodiment of the present invention, a policy group based file protection method for a file protection system is provided. The file protection method includes the following steps. Firstly, a file management driver is executed on a client device associated with the client. Then, a connection between the client device and the server is established for transmitting an identity data of the client to the server. The server determines whether the client belongs to a policy group according to the identity data. When the server determines that the client belongs to the policy group, the server transmits a certificate corresponding to the policy group to the client device. The file management driver determines whether to allow the file access application to execute the file open procedure and access the file based on the certificate received from the server upon detecting a request for executing a file open procedure and opening the file from the file access application, wherein the file access application is installed in the client device.

According to another exemplary embodiment of the present invention, a policy group based file protection method for a file protection system is provided. The file protection method includes the following steps. Firstly, a file management driver is executed on a client device associated with a client. Then, the client device establishes a connection with the server and transmits an identity data associated with the client to the server. The server subsequently determines whether the client belongs to a policy group according to the identity data. When the server determines that the client belongs to the policy group, the server transmits a certificate corresponding to the policy group to the client device, wherein the certificate includes a predefined file-accessing time. When the client initiates a file open procedure and opens the file using the client device within the predefined file-accessing time, the file management driver allows the file access application, which is installed in the client device to execute the file open procedure and access the file.

According to one exemplary embodiment of the present invention, a policy group based file protection system is provided. The file protection system comprises a server and at least one client. The server has a certificate corresponds to at least one policy group stored therein. The client has a client device. The client device includes a file management driver, a first memory unit, and a first processing unit. The file management driver is configured for transmitting an identity data of the client to the server to obtain the certificate corresponding to the policy group. The file management driver determines whether to allow the client device to access a file belonging to the policy group according to the certificate. The first memory unit is configured for storing the certificate and the identity data. The first processing unit is coupled to the first memory unit and operatively executes the file management driver. When the file management driver is executed and transmits the identity data to the server, the server determines whether the client belongs to the policy group according to the identity data. When the server determines that the client belongs to the policy group according to the identity data, the server transmits the certificate corresponding to the policy group to the client device. While the file management driver is executed, the file management driver operatively determines whether to allow the file access application which is installed in the client device to execute the file open procedure accessing the file based on the certificate received.

Additionally, an exemplary embodiment of the present invention provides a computer readable recording medium, which stores a computer executable program. When the computer readable recording medium is read by a processor, the processor executes the aforementioned method.

To sum up, the present invention provides a policy group based file protection system, a file protection method thereof, and a computer readable medium, which can improve the file-accessing convenience and the file-accessing efficiency for the user of the policy group based file protection system while maintain the security and confidentiality of the files in the policy group based file protection system.

In order to further understand the techniques, means and effects of the present invention, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 shows a diagram of a policy group based file protection system provided according to an exemplary embodiment of the present invention.

FIG. 2 shows a flowchart of a policy group of a policy group based file protection method provided according to an exemplary embodiment of the present invention.

FIG. 3 shows a function block diagram of the policy group based file protection system provided according to an exemplary embodiment of the present invention.

FIGS. 4-1 and 4-2 respectively show a flowchart diagram of a file access method of the policy group based file protection system provided according to an exemplary embodiment of the present invention.

FIG. 5 shows a flowchart of a file encryption method provided according to an exemplary embodiment of the present invention.

FIG. 6 shows a flowchart of a file decryption method provided according to an exemplary embodiment of the present invention.

FIG. 7 shows a flowchart of an offline working procedure for the policy group based file protection method provided according to an exemplary embodiment of the present invention.

FIG. 8 shows a flowchart of a method for configuration the policy group provided according to an exemplary embodiment of the present invention.

### DESCRIPTION OF THE EXEMPLARY EMBODIMENTS

The present invention provides a file protection system, a file protection method thereof, and a computer readable medium, which are used for increasing the file-access convenience for users. The present invention can effectively maintain necessary file securities and assure the confidentiality of file, such that the file accessing efficiency can be improved. The file protection method can classify at least one file in the file protection system according to a dynamically-configured policy group and correspondingly encrypt the file with a file encryption data.

Furthermore, the file protection method can actively determine whether the user belongs to the policy group linked with the file to decide whether to allow the user accessing the file associated with the policy group. Under the file protection system structured in the present invention, files being configured to be link with the policy group can only be accessed by the user belongs to the policy group. The file protection method provided can adaptively change file access authority of the user through dynamically configure the group member in the policy group and the files associated therewith. Thereby, the file protection method provided can effectively increase the file access security.

Reference will now be made in detail to the embodiments of the present disclosure, examples of which are illustrated in the accompanying drawings. Wherever possible, the same reference numbers are used in the drawings and the description to refer to the same or like parts.

[An Exemplary Embodiment of the File Protection System]

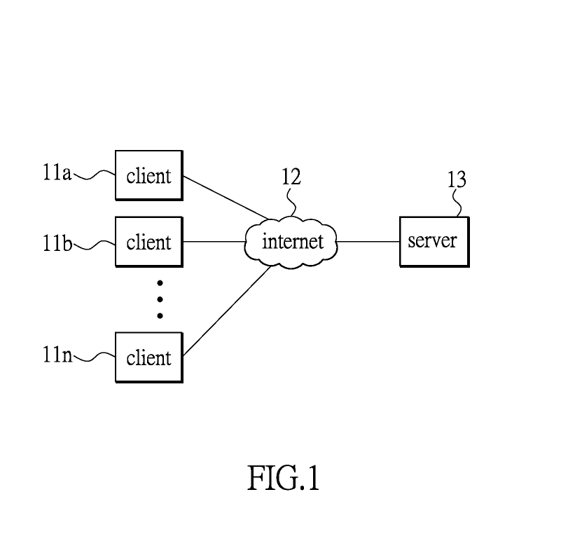

Please refer to FIG. 1, which shows a diagram illustrating a policy group based file protection system provided according to an exemplary embodiment of the present invention. In the instant embodiment, the file protection system includes clients 11a-11n and a server 13, wherein each client has a client device (not shown in FIG. 1). The client device can be a smart phone, PDA, tablet, laptop, desktop, or other computer apparatus that can install application. The client device of each client 11a-11n can be operated to connect to the server 13 through an internet 12 to perform data transmission.

In the instant embodiment, the clients 11a-11n may respectively have same or different client device. For example, the client device of client 11a-11n may all be desktop. For another example, the client device of the client 11a may be a PDA, the client device of the client 11b may be a laptop, while the client device of the client 11c may be a tablet. In short, the number of the clients and the type of the client devices may depend upon the actual architecture of the file protection system 1 and shall not be limited to the examples provided herein.

The clients 11a-11n can connect with the server 13 through the internet 12, respectively. The client 11a-11n may be wired or wirelessly connect to the server 13 in a direct or indirect manner and the instant embodiment is not limited thereto.

Furthermore, an operator of the server can define a policy group through a server (not shown in FIG. 1), wherein the policy group includes at least one client, e.g., clients 11a-11c. The clients of the policy group have the authority for accessing the files belongs to the policy group. Specifically, in the file protection system 1, all files belong to the policy group is encrypted with an encryption data. The encryption data can be encrypted when the client or the server is creating the file or accessing the file. Besides, in the file protection system 1, only the client of the policy group can acquire the encryption data and correspondingly decrypt the file. Thus, any client that are outside of the policy group is unable to access the files belongs to the policy group.

Specifically, the file protection system 1 of the instant embodiment adopts the advanced encrypting file system (AEFS) algorithm to encrypt the file. Those skilled in the art shall know the basic architecture of the operation system described as follows. The input and output operations of an application at the user mode may through pass the system IO manager and the filter manager of the kernel mode acquiring the file data called by the application from the file system. The file data obtained by the file system also passes the system IO manager and filter manager before reaching the application. Therefore, in the file protection system 1, a file management driver such as AEFS kernel driver, can be installed in the kernel mode of the operation system of the client device of the client 11, and the file management driver is linked with the filter manager. Such that, any operation or data flow associate with file addition, file edition, and file accessing in the operation system of the client device are to be intercepted by the file management driver.

When the file belongs to the policy group is generated or stored, the file management driver can determine whether to allow the client device to access the file according to the certificate received, i.e. determine whether to encrypt or decrypt the file. Regardless wherever and however the files being encrypted is transmitted, for all files that has being encrypted by the file management driver but has not been processed with encryption or decryption procedure, the file system of the client device is unable to recognize the file content so as to prevent the data leak.

It is worth to note that the policy group of the exemplary embodiment is a group having an authority for accessing specific files and the group is assigned at a server. In practice, when the file protection system 1 is applied to a data management system of an enterprise, the policy group can be defined according to the organizational structure of the enterprise, such as departments, groups, production lines, work tasks, or projects.

For example, people from different departments are generally assigned to cooperate with each other to accomplish the product during a product development cycle. Moreover, people from different departments may join to cooperate with each other at the different stage of the product development cycle so that there is a need for establishing a method for file exchange between different departments.

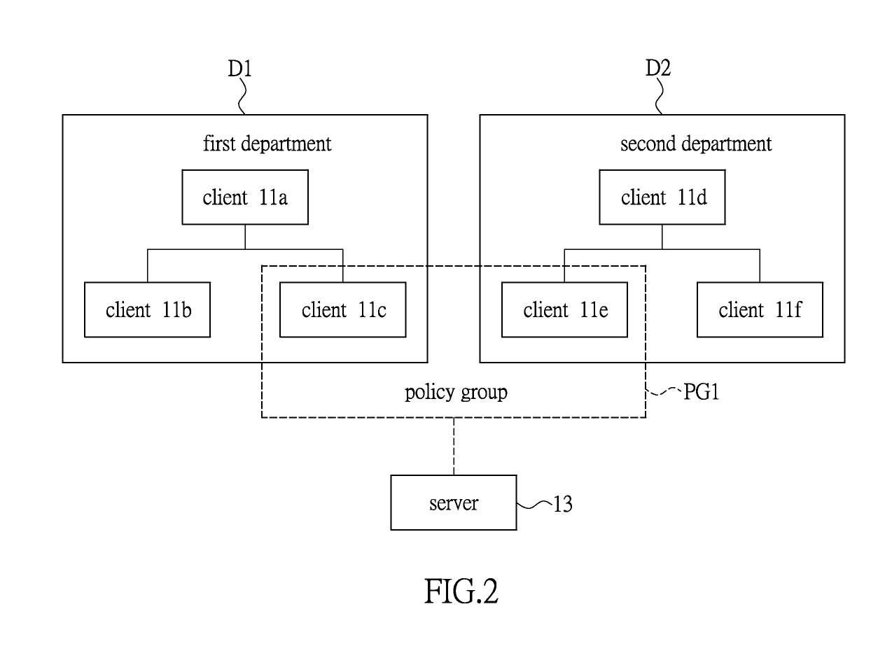

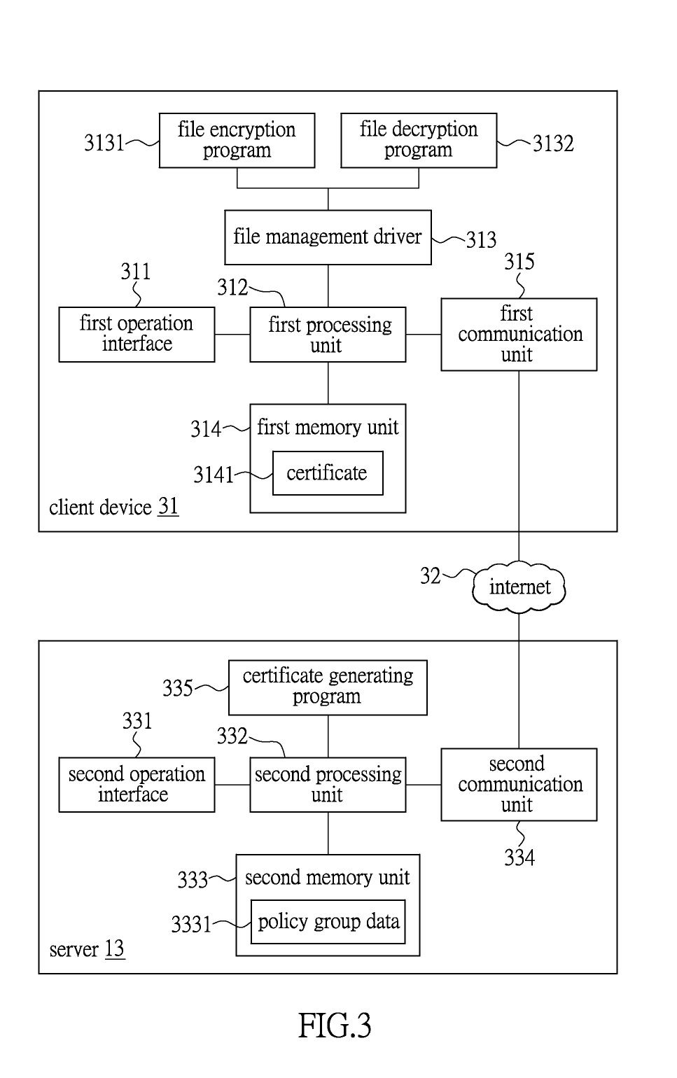

Please refer to FIG. 2, which show a diagram illustrating a policy group of a policy group based file protection method according to an exemplary embodiment of the present invention. If two departments in an enterprise company, i.e. the first department D1 (ex. research and development department) and the second department D2 (ex. marketing research department) are assigned to conduct a project research. However, the files individually owned by the first department D1 or the second department D2, the files cannot be shared.

As shown in FIG. 2, the first department D1, for example, can comprise the client 11a, the client lib, and the client 11c, wherein the authority of the client 11a (ex. manager) is higher than the authority of the client 11b and 11c (ex. staffs) given. That is the client 11a can freely access the files which are created by either the client 11b or the client 11c. Since both the client 11b and 11c have the same authority, thus the files created by the clients 11b and 11c individually cannot be mutually shared.

Similarly, the second department D2, for example, can comprise the client 11d, the client 11e, and the client 11f. The authority of the client 11d is higher than the authority of the client 11e and 11f. That is the client 11d can freely access the files created by either the client 11e or the client 11f. Since both the client 11e and 11f have the same authority, hence for the files created by the clients 11e and 11f. can not be mutually shared

The server 13 configures a policy group PG1 comprising the client 11c of the first department D1 and the client 11e of the second department D2 based on an assigned project (ex. a development task for a specific product). Because the client 11c and client 11e are both assigned to be within the same policy group PG1, the client 11c and client 11e can access the files created by each other. Since the client 11b and the client 11f are not belong to the policy group PG1, the client 11b and the client 11f therefore does not have access to the file of the policy group PG1.

The configuration method of the policy group, for example, the operator of the server may input the policy group related configuration data through an operation interface provided by a server (not shown in FIG. 2). The server subsequently generates and stores a policy group data corresponding to the policy group according to the configuration data. The policy group data records the identity data of the clients associated with the policy group (such as the account information and the device identification data of the client device) and an access control list associated with the files of the policy group. The server generates a certificate corresponding to the policy group based on the policy group data. The certificate can be used to identify whether the client is authorized for accessing the file of the policy group.

Simply speaking, taking the policy group of FIG. 2 as an example, when the client devices of the client 11b and 11c is connected to the server 13 through the internet 12, the client devices of the clients 11b and 11c can actively and transmit an identity data to the server 13 respectively for identify verification.

When the server 13 determines that the client 11c belongs to the policy group PG1 according to the identity data, the server 13 can transmit a certificate to the client device of the client 11c correspondingly. Afterward, the client device of the client 11c can be granted with the access to the files associated with the policy group PG1. When the server 13 determines that the client 11b does not belong to the policy group PG1, the server 13 would not transmit the certificate to the client device of the client lib. Therefore, the client device of the client 11b cannot access the files associated with the policy group PG1 as the client device does not have the certificate.

When the client device of the client 11b drives the file access application to generate a request for executing a file open procedure to open the file (the file belongs to the policy group PG1), the client device of the client 11b transmits a file access request to the server 13 to re-execute identify verification of the client 11b. When the server 13 determines that the client 11b does not belong to the policy group PG 1 according to the identity data, the server 13 immediately sends an invalid identity message back to the client device of the client 11b. And the client device of the client 11b is not allowed to access the file belonged to the policy group PG1 as the client device does not have the certificate, e.g., the client device cannot decrypt the file belonged to the policy group PG1.

That is, clients from the different departments can be correspondingly linked through the policy group configuration in the instant embodiment thereby achieve the objective of file exchange. The client of the same department with higher authority can have the same level of the authority assigned to the client with lower authority for accessing the file belonged to the policy group based on the configuration at the server 13. However, for a client having higher file access authority, but neither belonging to the policy group nor working in the same department, the client would not have the file access authority for accessing the file (i.e., the file belongs to the policy group) so as to protect and prevent the file from being leak easily.

The file protection system 1 of the instant embodiment can adaptively configure the policy group through the server 13, such that people from the different departments but the same policy group can share the files mutually. Thus, the file protection system 1 can resolve the issue that the files cannot be mutually shared among the departments, thereby increase work efficiency. Accordingly, the file protection system 1 can increase the convenience of the file access among the clients of the different departments while maintain the security and confidentiality of the files in the policy group based file protection system.

[An Exemplary Embodiment of the File Protection System]

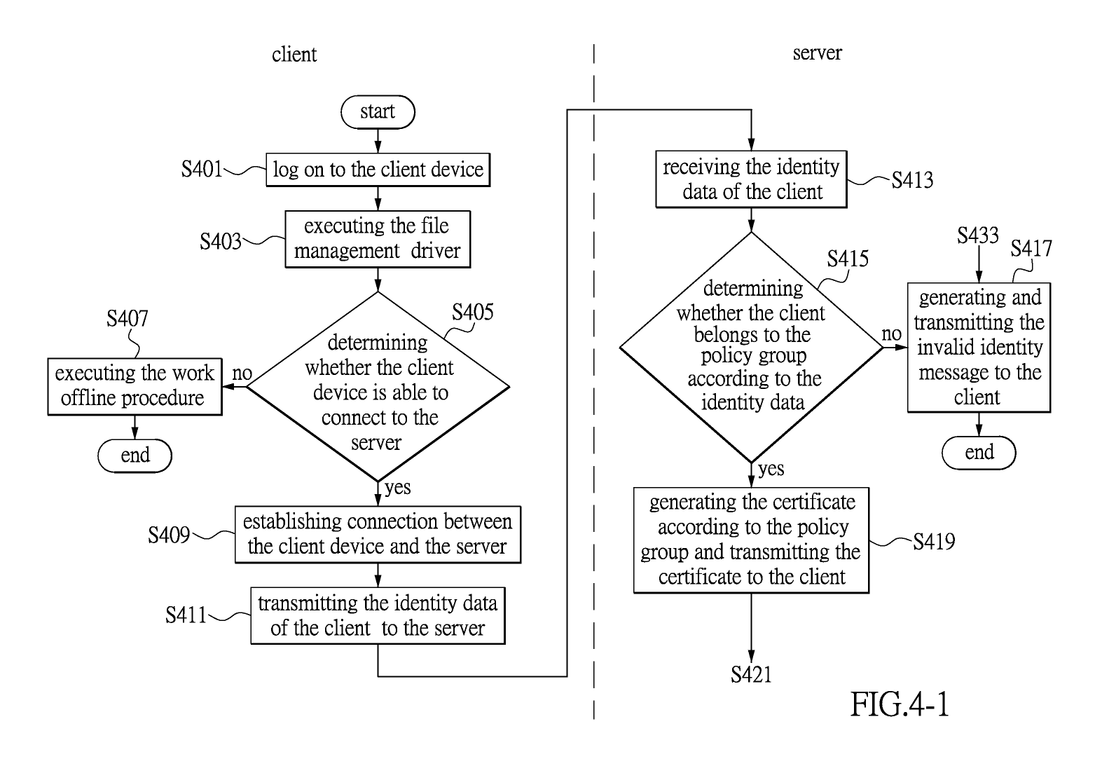

The structure of the client device of the client and the server is further described as follows. Please refer to FIG. 3, which shows a function block diagram illustrating the policy group based file protection system provided according to an exemplary embodiment of the present invention. In the present embodiment, the file protection system 3 includes a client device 31 of the client and a server 13. The client device 31 is connected to the server 13 through the internet for performing data transmission.

The client device 31, for example, may be a smart phone, PDA, tablet, laptop, and desktop or other computer apparatus that is capable of installing applications.

The client device 31 includes a first operation interface 311, a first processing unit 312, a file management driver 313, a first memory unit 314, and a first communication unit 315. The first operation interface 311, the file management driver 313, the first memory unit 314, and the first communication unit 315 are coupled to the first processing unit 312, respectively.

The first operation interface 311 is configured for providing a user of the client device 31 to input the account data of the client device 31 and operate the client device 31 (e.g., accessing the file stored in the client device).

The first processing unit 312 is the main operational core of the client device 31. The first processing unit 312 is used for initiating and executing the application installed in the client device 31. The first processing unit 312 can access the file through executing the application (ex. the file access application). The first processing unit 312 can further manage and configure the operation resources of the client device 31. The first unit 312 may be implemented by a microcontroller or an embedded controller disposed in the client device 31 and programmed with necessary firmware. However the instant embodiment is not limited thereto.

The file management driver 313 is a built-in application in the client device 31. The file management driver 313 is installed in the kernel mode of the operating system for controlling the file-accessing procedure of any files in the operation system belonging to the policy group.

The first memory unit 314 is used for storing the file, the application, and certificate 3141. The file format stored in the first memory unit 314 may be a standard digital document including but not limited to Microsoft Office files, text files, PDF, image files, or audio files. It shall be noted that the files stored in the first memory unit 314 can be any file formats depend upon actual operation system and/or operating method of the client device, and the instant embodiment is not limited thereto. The files stored in the first memory unit 314 are not limited to the files created or stored in the client device 31, all or some files may be stored in the cloud apparatus, mobile storage device or other any other storage device that is capable of storing the files. In other words, the files stored in the first memory unit 314 can be created by the application of the client device 31 or download from the server 13, and the instant embodiment is not limited thereto.

During the execution of the file management driver 313, the file management driver 313 can transmit the identity data of the client to the server 13 to acquire the certificate 3141 corresponding to the policy group. The file management driver 313 further determines whether the client can access the file belonging to the policy group according to the certificate 3141. The certificate 3141 records the encrypted data and the authorized information for the policy group data (ex. the access control list of the policy group).

Additionally, during the execution of the file management driver 313, any file accessing operation being instructed by the user of the client device 31 through the first operation interface 311 can be managed and controlled by the file management driver 313. Specifically, when the user of the client device 31 initiates the file access application through the first operation interface 311 to open the file belonging to the policy group, the file management driver 313 can determine whether to allow the client device 31 to access the file according to the certificate 3141. The file management driver 313 can also drive the file decryption program 3132 to decrypt the file according to the certificate 3141 to decrypt the encrypted data embedded in the file so as to enable the user of the client device 31 performing the file editing procedure, such as file-browsing, file modification, copying, pasting, and the like.

Next, when the user of the client device 31 instructs the file access application to close the file through the first operation interface 311, the file management driver 313 can control the file encryption program 3131 to encrypt the file according to the certificate 3141. That is the file management driver 313 can drive the file encryption program 3131 to generate and encrypt the file with the encrypted data corresponding to the policy group according to the certificate 3141.

The server 13 may include a second operation interface 331, a second processing unit 332, a second memory unit 333, a second communication unit 334, and a certificate generating program 335. The second operation interface 331, the second memory unit 333, the second communication unit 334, and the certificate generating program 335 are coupled to the second processing unit 332, respectively.

The second operation interface 331 is configured for providing the operator of the server 13 to input the configuration data corresponding to the policy group and generating a policy group data 3331. The content of the configuration data can comprise the policy group and client data of the client belonging to the policy group, the device identification data of the client device, the file configuration for the files belonging to the policy group, and etc. The policy group data can record the identity data of the client and the access control list of the file belonging to the policy group.

The second processing unit 332 is the main operational core of the server 13 such as the central processing unit (CPU) of the server 13. The second processing unit 332 is used for initiating and executing the application installed in the server 13. The second processing unit 332 can further manage and configure the operation resources of the server 13. The second processing unit 332 can also determine whether the client belongs to the policy group according to the identity data and the policy group data corresponding to the policy group.

For example, the second processing unit 332 can determine whether the client being a member of the policy group according to the account data of the client and the device identification data of the client device 31 (ex. device serial number, SSID, SIM, or other hardware information).

When the second processing unit 332 determines the client belongs to the policy group, the second processing unit 332 drives the certificate generating program 335 to generate the certificate corresponding to the policy group using the policy group data. The second processing unit 332 transmits the certificate to the first memory unit 314 of the client device 31 through the internet 32 using second communication unit 334. The certificate generating program 335 may be a built-in application in the server 13.

It shall be noted that when the operator of the server 13 modifies or edits the policy group data 3331, the second processing unit 332 can drive the certificate generating program 335 to regenerate the certificate corresponding to the policy group data 3331 edited and transmit the certificate regenerated to the client device 31 to renew the certificate 3141 presently used by the client device 31.

The second memory unit 333 is used to store the policy group data 3331. Specifically, the operator of the server 13 inputs the configuration data related to the policy group through the second operation interface 331 and the second processing unit 331 correspondingly generates the policy group data 3331. Moreover, the second memory unit 333 can used to store the file management driver 313, which can be provided for the client device 31 to download.

The second communication unit 334 is connected to the first communication unit 315 of the client device 31 through the internet 32. The client device 31 and server 13 of the file protection system 3 establish a connection through the first communication unit 315 and the second communication unit 334 to transmit or receive data from each other. The instant embodiment does not limit the type of hardware or the exact implementation of the first communication unit 315 and the second communication unit 334.

It is worth to note that the first memory unit 314 and the second memory unit 333 of the instant embodiment may be a flash memory, ROM, RAM, or other volatile/nonvolatile memory, and the instant embodiment is not limited thereto.

Briefly, after the user of the client device 31 inputs the account data through the first operation interface 311 and log on to the client device 31, the first processing unit 312 can automatically execute the file management driver 313. The file management driver 313 can drive the first communication unit 315 to establish a connection with the server 13. Then the file management driver 313 transmits the identity data to the server 13, so that the server 13 can determine whether the client belongs to the policy group. When the server 13 determines that the client belongs to the policy group, the server 13 immediately transmits the certificate corresponding to the policy group to the client device 31 through the internet 32 using the second communication unit 334. The client device 31 stores the certificate in the first memory unit 314. Afterward, when the user of the client device 31 initiates the file access application to access a file through the first operation interface 311, the file management driver 313 executes the file encryption program 3131 and the file decryption program 3132 to encrypt or decrypt the file to be accessed according to the certificate, to correspondingly perform the file encryption procedure and the file decryption procedure to the file.

It is worth to note that the user of the client device 31 can operate the first operation interface 311 and transmit the encrypted file to the server 13 through the first communication unit 315. The server 13 stores the encrypted file in the second memory unit 333. The user of the client device 31 may download the files of the policy group from the server 13. Thus, the instant embodiment does not limit the means which the client device 31 adopts for obtaining the file to be edited.

Additionally, regardless wherever and however the files encrypted is transmitted, for all files that has being encrypted by the file management driver but has not been processed with encryption or decryption procedure, the file system of the client device is unable to recognize the file content. Thereby prevent the data from unauthorized leaking.

[An Exemplary Embodiment of the File Access of the File Protection Method]

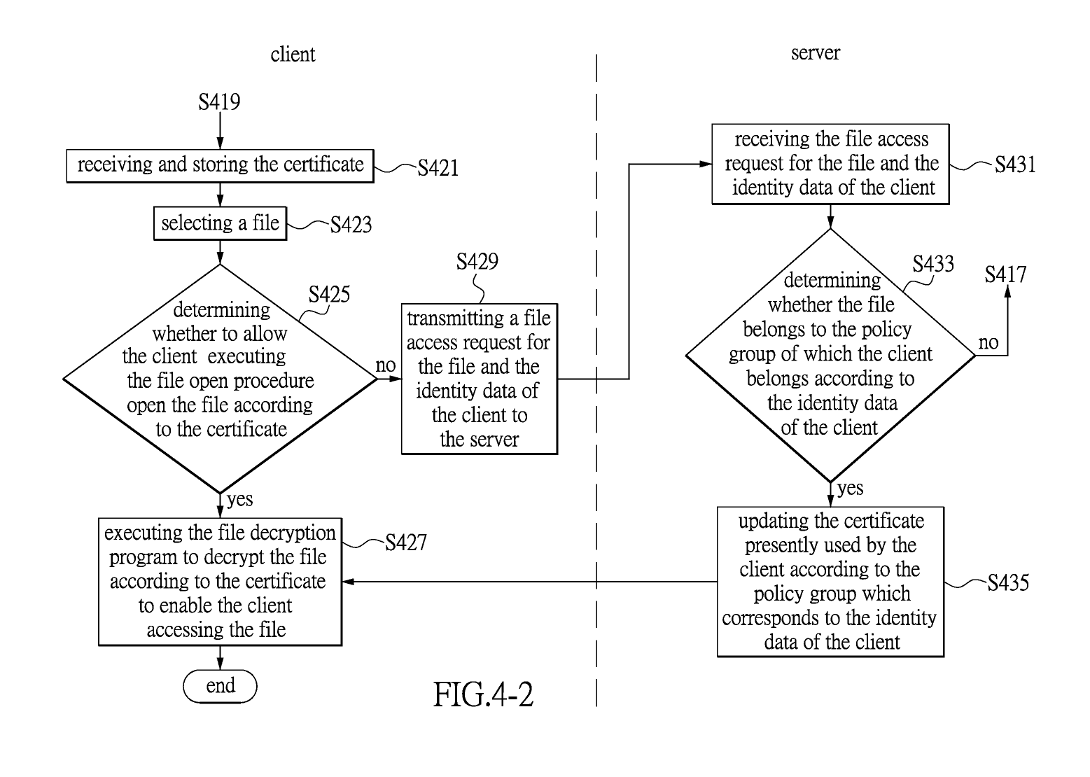

From the aforementioned exemplary embodiments, the present invention may generalize a file protection method, which is adapted for the aforementioned file protection. Please refer to FIG. 4-1, and FIG. 4-2 in conjunction with FIG. 3. FIG. 4-1 and FIG. 4-2 respectively show a flowchart illustrating a file access method for the policy group based file protection system provided according to an exemplary embodiment of the present invention.

Firstly, in the step S401, the user logs on to the client device 31 through the first operation interface 311. The user of the client device 31 can input the account data associated with the file protection system 3 through the first operation interface 311, such as the log-on account and password.

Next, in the step S403, the client device 31 automatically executes the file management driver 313. When the user logs on to the client device 31 initiating the operation system of the client device 31 (e.g., Window operating system, android operating system, or iOS), the first processing unit 312 of the client device 31 automatically executes the file management driver 313.

Afterward, in the step S405, the file management driver 313 determines whether the client device is able to connect to the server 13. The file management driver 313 may determines whether the client device 31 can connect to the server 13 through the internet 32 using the first communication unit 315.

When the file management driver 313 determines that the client device 31 is unable to connect to the server 13, the step S407 is executed. On the contrary, when the file management driver 313 determines that the client device 31 can connect to the server 13, the step S409 is executed.

In the step S407, the file management driver 313 drives the first processing unit 312 to execute the offline working procedure. Particularly, in the offline working procedure, the file management driver 313 determines whether the client device 31 has the offline certificate. The file management driver 313 determines whether to allow the client device 31 to access the file belonging to the policy group according to the offline certificate. The specific implementation method for the offline working procedure is will be described in the later embodiment, and further descriptions are hereby omitted.

In the step S409, the file management driver 313 of the client device 31 drives the first communication unit 315 to establish a connection between the client device 31 and the server 13. Next, in the step S411, the file management driver 313 drives the first communication unit 315 to transmit the identity data corresponding to the client to the server 13. The identity data, for example may be at least one of the account data of the client, the device serial number of the client device 31, SSID, or the combination thereof. The file management driver 313 can transmit the identity data of the client to the server 13.

Afterward, in the step S413, the server 13 receives the identity data transmitted by the client through the second communication unit 334.

In the step S415, the second processing unit 332 of the server 13 compares the identity data of the client with the policy group data corresponding to the policy group stored in the second memory unit 333 of the server 13 to determine whether the client belongs to the policy group. The second processing unit 332 can determine whether the client belongs to the policy group by determining whether the policy group data 3331 contains the information related to the client and the client device.

When the second processing unit 332 determines that the client does not belong to the policy group, the step S417 is executed. On the contrary, when the second processing unit 332 determines that the client belongs to the policy group, the step S419 is executed.

In the Step S417, the second processing unit 332 operatively generates and transmits the invalid identity message to the client through the second communication unit 334. The invalid identity message is displayed on the first operation interface 311 of the client device 31. Additionally, when the file belongs to the policy group is selected by the client device 31 through the first operation interface 311, the file management driver 313 forbids the built-in file access application of the client device 31 to open the file and displays the file open prohibited message on the first operation interface 311.

In the step S419, the second processing unit 332 drives the certificate generating program 335 to generate the certificate corresponding to the policy group using the policy group data. The second processing unit 332 transmits the certificate to the client device 31 associated with the client through the second communication unit 334.

Next, in the step S421, the client device 31 receives the certificate 3141 from the server 13 and stores the certificate 3141 in the first memory unit 314.

In the step S423, the user of the client device 31 selects the file to be opened through the first operation interface 311. In the step S425, when the file management driver 313 of the client device 31 detects a request for executing a file open procedure, the file management driver 313 operatively determines whether to allow the file access application executing the file open procedure for accessing the file according to the certificate 3141. The request is executed by the file access application installed in the client device 31. The file management driver 313 determines whether the client device 31 has the authority for opening the file of the policy group. When the file management driver 313 allows the file access application to open the file, the step S427 is executed. On the contrary, when the file management driver 313 does not authorize the file access application to open the file, the step S429 is executed.

In the step S427, the file management driver 313 drives the file decryption program 3132, which is build-in in the client device 31 to execute the file decryption procedure to the file so as to allow the file access application to open and access the file.

In the step S429, When the file management driver 313 does not allow the file access application to open the file (e.g., when errors are occurred during verification of the certificate, or the policy group which the file belongs to is not the same as the policy group which the client belongs to), the client device 31 transmits a file access request for the file and the identity data of the client to the server 13 through the internet 32 using the first communication unit 315, to have an advanced certification verification.

In the step S431, the second processing unit 332 of the server 13 receives the file access request for the file and the identity data of the client through the second communication unit 334. In the step S433, the second processing unit 332 determines whether the file to be opened belongs to the policy group according to the access control list defined in the policy group data. At the same time, the second processing unit 332 also determines whether the client belongs to the policy group and the validity of the certificate according to the policy group data.

When the second processing unit 332 determines that the file does not belong to the policy group which the client belongs to, or the client does not belong to the policy group which the file belongs to, the step S417 is executed. When the second processing unit 332 determines that the file belongs to the policy group which the client belongs to, the step S435 is executed.

In the step S435, the second processing unit 332 renews the certificate 2141 which corresponds to the policy group and is used presently by the client according to the identity data of the client and executes step S427.

Incidentally, after the client belongs to the policy group is verified, the client can freely access the file belongs to the policy group within a permissive time. Specifically, after the server 13 has verified the identity of the user of the client device 31, the server 13 transmits the certificate recoding a predefined file accessing time. The predefined file accessing time, may be for example, 3 hours. During the predefined file accessing time (i.e. 3 hours), when the user operates the client device 31 executing the file open procedure and opening the file belongs to the policy group, the file management driver 313 allows the file access application of the client device 31 to execute the file open procedure to open the file without any further verification.

Detailed descriptions on the operations of the file management driver 313 in executing the file encryption/decryption procedure to open/close a file chosen by the user of the client device 31 using the first operation interface 311 are provided in the subsequent paragraph.

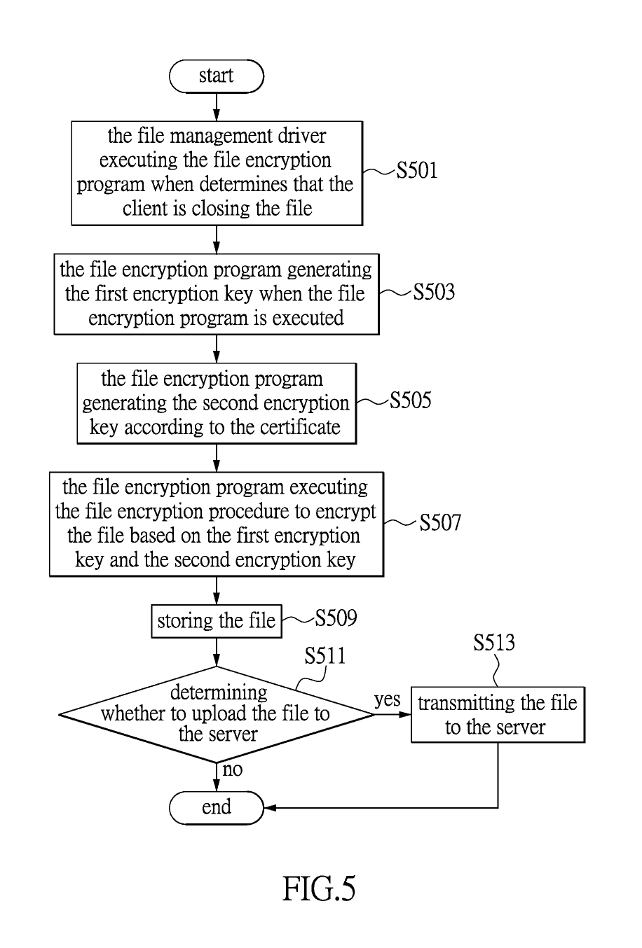

Please refer to FIG. 5 in conjunction with FIG. 3. FIG. 5 shows a flowchart of a file encryption method provided according to an exemplary embodiment of the present invention. As previously described the file encryption program 3131 herein adopts the AEFS algorithm for encrypting the file to be encrypted.

In the step S501, when the file management driver 313 detects that the file access application is executing a file closing procedure to close the file, the file management driver 313 operatively activates the file encryption program. When the user of the client device 31 instructs to close the file through the first operation interface 311, the file management driver 313 immediately initiates the file encryption program to encrypt the file with the encryption data.

In the step S503, the file encryption program 3131 can generate a first file encrypted key using random data during the execution, and store the first file encrypted key in the first memory unit 314. In the step S505, the file encryption program 3131 generates the second file encrypted key according to the encrypted data of the policy group in the certificate 3141. In the step S507, the file encryption program 3131 executes the file encryption procedure to encrypt the file according to the first file encrypted key and the second file encrypted key.

It is worth to note that the file encryption program 3131 adopts the symmetric encryption algorithm for generating the first file encrypted key while adopts the asymmetric encryption algorithm for generating the second file encrypted key according to the certificate 3141, however the instant embodiment is not limited thereto. To sum up, the instant embodiment does not limit the methods adopted by the file encryption program 3131 for encrypting the file. Moreover, those skilled in the art shall know the implementation of the symmetric encryption algorithm and the asymmetric encryption algorithm, and further descriptions are hereby omitted.

Next, in the step S509, the file encryption program 3131 can store the encrypted file in the first memory unit 314. In the step S511, the file management driver determines whether to transmit the encrypted file to the server 13. For example, the file management driver 313 can determine whether to transmit the encrypted file to the server 13 based on the file accessing operations made by the user on the first operation interface 311 of the client device 31.

When the file management driver 313 determines to transmit the encrypted file to the server 13, the step S513 is executed. On the contrary, when the file management driver 313 determines that no need to transmit the encrypted file to the server 13, terminates the operation of file encryption procedure.

In addition, in the step S511, the file management driver 313 determines whether to transmit the encrypted file to the server 13. It can be determined according as whether the server 13 transmits the upload instruction to the client device 31. To sum up, whether uploading the encrypted file is not used to limit the exemplary embodiment. Besides, the goal that the client uploads the file to can be determined by the setting of the file management driver 313 or setting of the user of the client device 31. However, the instant embodiment is not limited thereto.

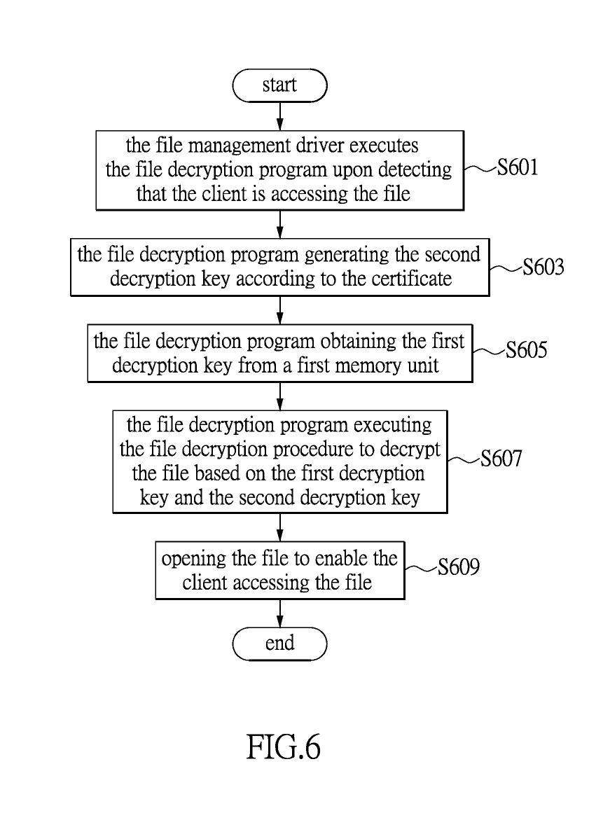

Next, please refer to FIG. 6 in conjunction with FIG. 3. FIG. 6 shows a flowchart illustrating a file decryption method according to an exemplary embodiment of the present invention. The file decryption method can be executed during the step S427 shown in FIG. 4. When the file management driver 313 allows the file access application, which is built-in the client device 31 to execute the file open procedure, the file management driver 313 operatively drives the file decryption program 3132 to execute the file decryption procedure and decrypt the file.

Specifically, in the step S601, when the file management driver 313 determines to allow the file access application of the client device 31 to open the file, the file management driver 313 operatively drives the file decryption program 3132 to decrypt the file.

In the step S603, the file decryption program 3132 can perform computations to generate the second file decrypted key according to the encrypted data in the certificate 3141, wherein the second file decrypted key corresponds to the second file encrypted key. The certificate 3141 is stored in the first memory unit 314. In the step S605, the file decryption program 3132 obtains the first file decrypted key corresponding to the first file encrypted key from the first memory unit 314. In the step S607, the file decryption program 3132 executes the file decryption procedure to decrypt the file according to the first file decrypted key and the second file decrypted key.

In the step S609, the file access application opens the file and enables the user of the client device 31 to execute the file editing operations, such as file-browsing, file modification, and the like.

[An Exemplary Embodiment of the Offline Working Procedure of the File Protection Method]

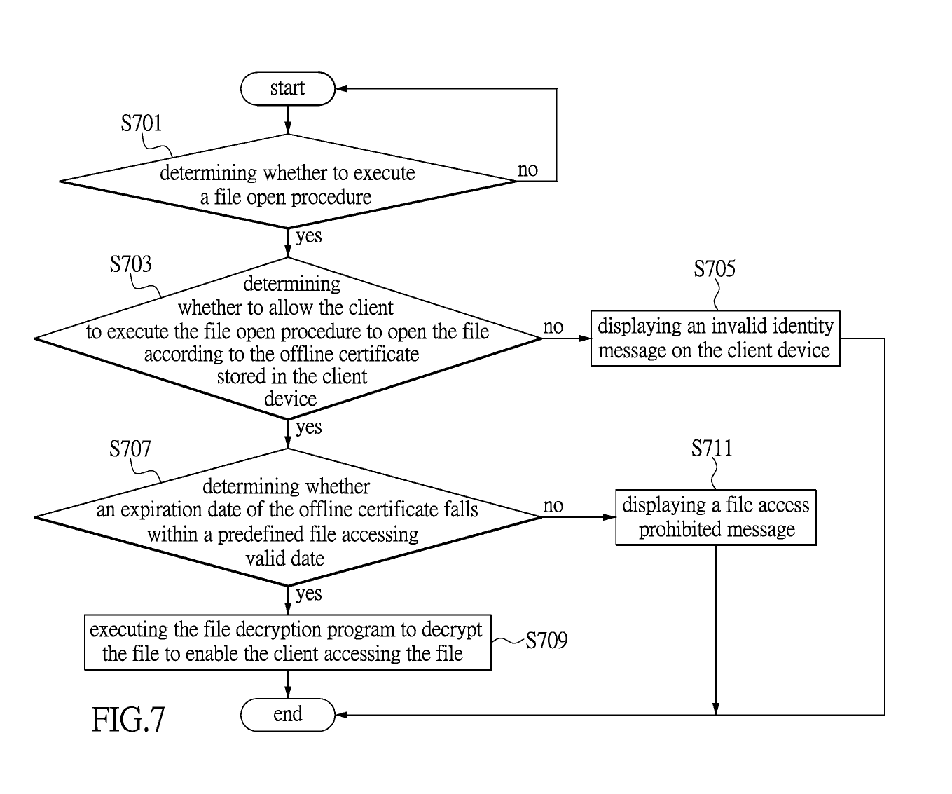

Please refer to FIG. 7 in conjunction with FIG. 3. FIG. 7 shows a flowchart illustrating an offline working procedure for the policy group based file protection method provided according to an exemplary embodiment of the present invention. When the client device 31 is unable to connect with the server 13 during a period of time, the file management driver 313 executes an offline working procedure (such as the step S407 of FIG. 4-1) causing the first processing unit 312 to operate in an offline working mode.

In the step S701, the file management driver 313 can determine whether the file access application is executing the file open procedure to open any policy group related file, i.e. to detect whether the user of the client device 31 drives the file access application to open the file of the policy group.

When the file management driver 313 determines that the user of the client device 31 did not initiate the file access application to open the file, the step S701 is executed and the file management driver 313 continually determines whether the user of the client device 31 is opening the file of the policy group. On the contrary, when the file management driver 313 determines that the user of the client device 31 is driving the file access application to open the file, the step S703 is executed.

In the step S703, the file management driver 313 determines whether to allow the file access application of the client device 31 to execute a file open procedure and open the file according to the offline certificate, wherein the offline certificate is stored in the first memory unit 314 of the client device 31. The offline certificate has an expiration date, the encrypted data, and the authorization data of the policy group data (e.g., an access control list). Specifically, the file management driver 313 may determine whether a file belongs to the policy group according to an access control list of the offline certificate, wherein the access control list contains the list of files associated with the policy group.

When the file management driver 313 determines that the file access application of the client device 31 is allowed to execute the file open procedure to open the file, the step S707 is executed. On the contrary, when the file management driver 313 determines that the file access application of the client device 31 is not allowed to execute the file open procedure and open the file, the step S705 is executed.

In the step S705, the file management driver 313 generates and displays an invalid identity message on the first operation interface 311, and prohibits the file access application to execute the file open procedure to open the file.

In the step S707, the file management program 313 determines whether the expiration date of the offline certificate falls within a predefined file access expiration date (ex. 24 hours). When the file management driver 313 determines that the expiration date of the offline certificate falls within the predefined file access expiration date, the step S709 is executed. On the contrary, when the file management driver 313 determines the expiration date of the offline certificate has exceeds the predefined file access expiration date, the step S711 is executed.

In the step S709, the file management driver 313 drives the file decryption program 3132 to decrypt the file according to the offline certificate using the file decryption method illustrated in FIG. 6, so that the client can access the file. In the step S711, the file management driver 313 operatively generates and displays a file access prohibited message on the first operation interface 311.

[An Exemplary Embodiment of the Policy Group Setting of the File Protection Method]

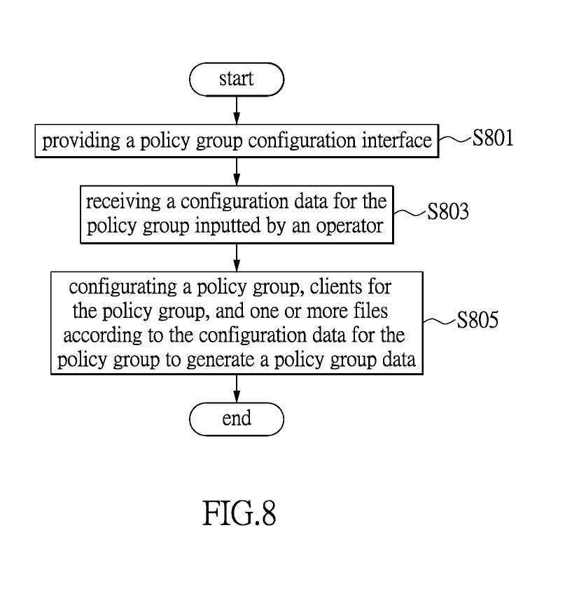

Please refer to FIG. 8 in conjunction with FIG. 3. FIG. 8 shows a flowchart illustrating a method for configuring the policy group provided according to an exemplary embodiment of the present invention.

In the step S801, the second processing unit of the server 13 provides a policy group configuration interface through the second operation interface 331. Next, in the step S803, the server 13 receives a configuration data associated with the policy group being inputted by an operator through the policy group configuration interface, wherein the configuration data may the client data of the client belonging to the policy group and an access control list associated with files of the policy group. In the step S805, the server 13 generates a policy group data 3331 according to the configuration data of the policy group, wherein the policy group data 3331 records the identity data of the client related to the policy group (e.g., the log-on account data and the device identification data of the client device) and the access control list containing the files belonging to the policy group. When the operator of the server 13 updates the policy group data using the policy group configuration interface, the second processing unit 332 actively causes the certificate generating program 335 to generate the modified certificate. And the modified certificate is then transmitted to the client device 31 to update the certificate 3141 stored in the client device 21.

In addition, the present invention also discloses a computer readable recording medium, wherein the computer readable recording medium stores the computer executable program code for executing the file protection method depicted in FIG. 4, the file encryption method depicted in FIG. 5, the file decryption method depicted in FIG. 6, the offline working procedure depicted in FIG. 7, and the policy group setting method depicted FIG. 8. The computer readable recording medium may be a floppy disk, a hard disk, a compact disk (CD), a flash drive, a magnetic tape, an accessible online storage database or any type of storage medium having the similar functionality known to those skilled in the art.

In summary, the exemplary embodiments of the present invention provides a policy group based file protection system, a file protection method thereof, and a computer readable medium which can improve the file-accessing convenience and the file-accessing efficiency for the users in the policy group based file protection system while maintain the required security and confidentiality of the files in the policy group based file protection system.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A policy group based file protection method, adapted for a file protection system, which is used to have at least one client connecting to a server through an internet, and to protect a file, the file protection method comprising:
executing a file management driver on a client device associated with the client;
establishing a connection between the client device and the server, and transmitting an identity data of the client to the server, wherein the identity data comprises of an account data of the client and a device identification data of the client device;
the server determining whether the client belongs to a policy group according to the identity data;
when the server determines that the client belongs to the policy group, the server transmits a certificate corresponding to the policy group to the client device; and
when the file management driver of the client device detects a request from a file access application installed in the client device, for executing a file open procedure and opening the file, the file management driver determines whether to allow the file access application to execute the file open procedure and accessing the file based on the certificate received.

2. The file protection method according to claim 1, further comprising:
when the server determines that the client does not belong to the policy group, the server transmits an invalid identity message to the client device and the invalid identity message is displayed on a first operation interface of the client device.

3. The file protection method according to claim 1, further comprising:
when the file management driver allows the client device to execute the file open procedure and access the file based on the certificate received, the file management driver operatively causes a file decryption program to execute a file decryption procedure and decrypt the file using the certificate received; and
the file management driver permitting the file access application to open the file through the file open procedure.

4. The file protection method according to claim 3, further comprising:
when the file management driver determines to not allow the file access application to execute the file open procedure to open the file based on the certificate received, the file management driver causes the client device to transmit a file access request of the file and the identity data to the server; and
when the server determines that the file does not belong to the policy group according to the file access request and an access control list, the server transmits an invalid identity message to the client device.

5. The file protection method according to claim 3, wherein the step of executing the file decryption procedure, further comprises:
the file decryption program accessing a memory unit of the client device to obtain a first decryption key corresponding to the file stored therein;
the file decryption program obtaining a second decryption key of the policy group based on the certificate; and
the file decryption program executing the file decryption procedure to decrypt the file according to the first decryption key and the second decryption key.

6. The file protection method according to claim 3, wherein the step after opening the file, further comprises:
the file management driver determining whether the client device is executing a file closing procedure through the file access application;
when the file management driver determines that the client device is executing the file closing procedure corresponding to the file, the file management driver drives a file encryption program to execute a file encryption procedure based on the certificate;
the file encryption program generating a first encryption key corresponding to the file during the execution of the file encryption procedure;
the file encryption program generating a second encryption key corresponding to the policy group according to the certificate; and
the file encryption program executing the file encryption procedure to encrypt the file with an encryption data by using the first encryption key and the second encryption key.

7. The file protection method according to claim 6, wherein the file encryption program generates the first encryption key using a symmetric encryption algorithm, and generates the second encryption key based on the certificate using an asymmetric encryption algorithm.

8. The file protection method according to claim 1, wherein the step of connecting the client and the server, further comprises:
when the client is unable to connect to the server, the file management driver executes an offline working procedure;
when the file management driver determines that the client is accessing the file with the file open procedure using the client device, the file management driver determines whether to allow the client device to execute the file open procedure and access the file according to an offline certificate stored in the client device; and
when the file management driver allows the client device to the file according to the offline certificate, the file management driver drives a file decryption program to execute a file decryption procedure according to the offline certificate.

9. The file protection method according to claim 8, wherein the step of the file management driver determining whether to allow the client device to execute the file open procedure and access the file according on the offline certificate, further comprising:
the file management driver determining whether an expiration date of the offline certificate is within a predefined file access expiration date; and
when the file management driver determines that the expiration date of the offline certificate exceeds the predefined file access expiration date, prohibits the client device from executing the file open procedure and opening the file, and displays a file access prohibited message is on the client device.

10. A policy group based file protection system, comprising:
a server having a certificate corresponds to at least one policy group stored therein; and
at least one client having a client device comprising:
a file management driver, configured for transmitting an identity data of the client device to the server so as to obtain the certificate corresponding to policy group, and the file management driver determining whether to allow the client device to access a file belonging to the policy group according to the certificate.
a first memory unit, storing the certificate and the identity data, wherein the identity data comprises of an account data of the client and a device identification data of the client device; and
a first processing unit, coupled to the first memory unit, operatively executing the file management driver;
wherein when the file management driver is executed, the file management driver operative to transmit the identity data to the server, and the server determines whether the client belongs to the policy group according to the identity data; wherein when the server determines that the client belongs to the policy group, the server transmits the certificate corresponding to the policy group to the client device;
wherein while the file management driver is executed, the file management driver operatively determines whether to allow a file access application executing the file open procedure accessing the file based on the certificate received, upon detecting a request for executing a file open procedure, wherein the file access application installed in the client device.

11. The file protection system according to claim 10, wherein the client device further comprising:
a file encryption program, configured for operatively executing a file encryption procedure to encrypt the file with an encryption data while the first processing unit executing the file management driver;
a file decryption program, configured for operatively executing a file decryption procedure to decrypt the file while the first processing unit is executed by the file management driver; and
a first communication unit, configured for connecting to the server.

12. The file protection system according to claim 10, wherein the client device further comprising:
a first operation interface, configure for providing the client to input an account data;
wherein, when the server determines that the client does not belong to the policy group, the server transmits a message of an invalid identity to the client device and displayed on the first operation interface.

13. The file protection system according to claim 12, wherein the server further comprising:
a second operation interface, configured for an operator to input a configuration data corresponding to the policy group and operatively generating a policy group data, wherein the policy group data comprises the identity data of the client an access control list, and the certificate of the policy group;
wherein the server determines whether the file belongs to the policy group according to the access control list.

14. A computer readable recording medium, wherein the computer readable recording medium stores a computer executable program, when the computer readable recording medium is read by a processor, the processor executes the computer executable program and implements the steps according to claim 1.
